(19) United States
(12) Patent Application Publication
(10) Pub. No.: US 2010/0203215 A1
(43) Pub. Date: Aug. 12, 2010

(54) PRODUCING FROZEN DESSERTS ON THE BASIS OF A PREMIXED BATCH OF INGREDIENTS

(75) Inventor: Flavio Russo, Parma (IT)

Correspondence Address: K&L Gates LLP, P.O. Box 1135, CHICAGO, IL, 60690, US

(73) Assignee: NESTEC S.A., Vevey (CH)

(21) Appl. No.: 12/665,399

(22) PCT Filed: Jun. 18, 2008
(86) PCT No.: PCT/EP08/57658

§ 371 Date: Dec. 18, 2009

(30) Foreign Application Priority Data
Jun. 25, 2007 (EP) 07111002.7

(51) Int. Cl. A23G 9/44; A23G 9/04

(52) U.S. Cl. 426/565; 426/531; 426/393

(57) ABSTRACT

A method for producing frozen desserts comprises the steps of: producing a frozen premix package at a first site, transporting the frozen premix package in the frozen state to a different, second site, and producing a frozen dessert, using a batch freezer, or a soft-ice machine on the basis of the frozen premix package defrosted at the second site, for instance a point of sale. The premix package contains a batch of premixed pasteurized ingredients for the production of a frozen dessert, wherein the premix is in a sealed packaging, and wherein the premix is in a frozen state.

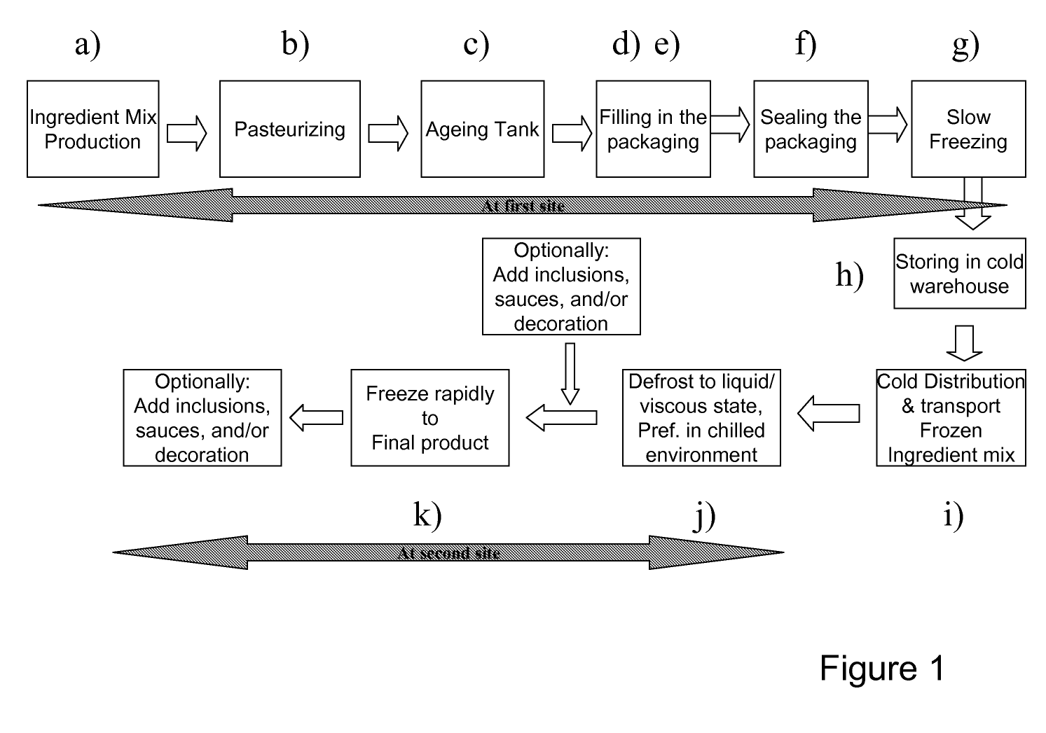

The present invention relates to the production of frozen desserts, such as e.g. ice creams, sherbets, soft-ices or sundaes. The invention particularly relates to the production of such frozen desserts using frozen premixed batches of ingredients.

It is known to use premixed batches of ingredients for the production of frozen dessert.

The following premixes are known for the production of ice cream:
Fresh pasteurized liquids that require constant refrigeration until needed. They can be stored during a limited number of days, depending on the type of the raw materials used, as well as product pH, before being spoiled by bacterial contamination. Quality can be severely compromised by bacterial contamination and handlers must exercise caution to maintain quality.
Powdered mixes. These are a dried version of the liquid mixes. They have the advantage of easy distribution and can be stored for long periods of time without spoiling. Water, fresh milk or other fresh ingredients (e.g. fresh cream) must be added prior to being churned and frozen. The disadvantage is that water or the other liquid ingredients' quality cannot be guaranteed and some operators can put too much or too little liquid into the premix resulting in a varied non-homogeneous quality of the final ice cream. Moreover, the heating accompanying the drying process of the powder can be detrimental for the quality of the product (cooked taste, degradation of flavours, . . . ). In addition, several steps are necessary to prepare properly the liquid mix, like weighting separately the powders and the liquids, properly dissolving the powders into the liquids and stirring properly in order to assure a good dispersion and have an homogeneous mix—those operation are preferably done using tools (i.e., buckets, stirrers) that could be source of bacteriological contaminations. It is also known that in many cases the premix obtained needs to be pasteurized prior to be processed to a batch freezer or in a soft-ice machine.
Ultra Hight Temperature processing or Ultra Heat Treatment (both abbreviated UHT), or yet Ultra High Pressure Homogenization processing (abbreviated UHPH) and other similar sterilization treatments result in a sterilized liquid packed in sealed, sterile bags. It can last a very long time with or without refrigeration and can be poured into the batch freezer or the soft-ice machine immediately upon opening. Quality can be guaranteed and bacterial counts at that stage are near zero except from some kind of spores that are from literature resistant such treatments. However, the heating has again the above-mentioned disadvantages.

Pre-mixes as discussed above are e.g. described in the Wikipedia Internet Encyclopedia.

Each of these known approaches suffers from disadvantages, especially as to the degradation of a “fresh” appearance and taste of the resulting frozen dessert product. On the other hand, such ingredients are particularly prone to degradation and contamination.

EP 0277354 teaches for example a premix for ice foods from which milk shake can be produced upon addition of milk. The disclosed premix is limited in terms of composition as it must comprise specific ingredients that should make it resistant to a high temperature sterilization process. In particular it comprises, as essential components, (1) an unsaturated fatty acid-free oil, (2) a glycerin fatty acid ester and (3) a mixture of pectin and pre-gelatinized starch.

In order to produce the frozen dessert, the premixes of ingredients known from the prior art are usually aerated and then frozen such that the desired ice crystal structure is achieved. For example the premix described in EP 0277354 consisting in a sterilized emulsion is frozen and reserved in a refrigerator. It is transported as such and mixed with milk before being consumed. The shelf life of the frozen premix is limited and the quality of the product might be altered during transport and before being finally consumed.

The invention overcomes the problems above-mentioned and proposes a technology adapted to any formulation to prepare a frozen dessert such as an ice cream or a sherbet, ensuring at the same time a high quality of the resulting product and a reasonable shelf life of the premix. The quality can be expressed in terms of:
no “cooked” off-taste caused by a heat-triggered Maillard reaction, and preservation of the original “fresh” taste of the ingredients.
no coloring or color change caused by heating,
no heat-degradation of flavours, or disappearance of low-boiling point flavours' carriers.

Therefore, the invention advantageously allows preparing and distributing frozen desserts with a fresh quality similar to its quality at production time, thanks to a cold distribution delivery system.

This object is achieved by means of the features of the independent claims. The dependent claims develop further the central idea of the present invention.

According to a first aspect of the present invention, a premix package contains a batch of premixed pasteurized ingredients for the production of a frozen dessert. The premix is in a sealed packaging. The premix is in a frozen state, is not aerated and preferably contains milk constituents (e.g. milk fat, proteins and/or lactose).The above-mentioned premix can also contain fruit preparations, with or without visible pieces.

The term “frozen dessert” encompasses a wide variety of ready-to-consume products such as e.g. ice cream, frozen custard, ice milk, sherbet, sorbet, water ice, soft-ice, sundae, frozen dairy confections, frozen confections, dietary frozen desserts, Mellorine and non-dairy desserts, frozen puddings and frozen mousses.

A frozen premix according to the present invention is not aerated. It can be further distinguished from a ready-to-consumed frozen dessert via its crystalline structure, as the ice crystals are much bigger compared to the ready-to-consumed frozen dessert. This stems from the fact that the freezing of the premix can be done much slower than the rapid freezing when producing the ready-to-consumed frozen dessert. Thus the frozen premix is a block of ice, or in a “frozen block state”, i.e. in a state where it is stored, transported, delivered or maintained at a temperature below −18° C.

The ingredients can be those typically used in the formulation of sherbet, ice cream or other frozen desserts.

Another aspect of the invention relates to a method for producing frozen desserts which comprises the steps of:
producing a sealed premix package containing a batch of premixed, pasteurized ingredients for the production of a frozen dessert, and
freezing the premix package in a frozen block state, at a first site;
transporting the frozen premix package in the frozen state to a different, second site, and
producing a preferably aerated frozen dessert, using a batch freezer or a soft-ice machine, on the basis of the frozen premix package.

A frozen premix package as explained above is produced at a first site.

The frozen premix package is then stored, transported and distributed in the frozen state (“cold chain”) to a different, second site.

A frozen dessert is then produced, using a batch freezer or a soft-ice machine, from the frozen premix package.

In particular the frozen premix package is first defrosted at the second site before it is processed into the batch freezer or in a soft-ice machine. Preferably it is entirely defrosted to a liquid or viscous state and the freezing of the ready-to-eat frozen dessert product starts out of this viscous or liquid state.

Typically the defrosting stage is done in a chilled environment, preferably under controlled temperature conditions.

The premix of ingredients is microbiologically inactivated, e.g. it can be pasteurized before being packed and frozen. Hitherto the use of pasteurized mixes in freezer machines was strongly limited by the limited shelf-life of the pasteurized mix, in a way that production of the pasteurized mix and its final transformation in the final form needed to take place or in the same factory/laboratory or in the immediate vicinity. Alternatively an appropriate quick delivery under controlled chilled transports was needed, as it happens in milk distribution chain, thus limiting the reaching of remote sites and making difficult the logistics at the final site, where the mix was then processed and transformed in its final form.

The present invention advantageously obviates these problems.

The ingredient mix can be frozen after being filled in the package and after the package has been sealed.

The premix ingredients are not subjected to an Ultra Hight Temperature Treatment or similar ones at the first site.

The second site can be a vending parlor, like an ice-cream corner, or an ice-cream shop, or a place where above mentioned frozen desserts are produced and sold, even in mobile equipped units.

Further objects, aspects and advantages of the invention will become evident when reading the following detailed explanation of an exemplary embodiment of the invention, when taken in conjunction with the figure of the enclosed drawing.

The only figure shows a production and distribution chain for frozen desserts according to the invention.

The shown technology allows to deliver a high quality of ice cream, sherbet, or other form of frozen dessert in a way that fresh ice cream/sherbet/frozen dessert can be prepared using a freezer or soft ice machine in a distant point of sales or other remote locations, preserving the quality of the mix at the same level of its production time through a cold distribution delivery system.

As shown in the figure, the distribution chain comprises:

a) A production plant for frozen ingredient mixes. Preferably the ingredient mix is present in a viscous or liquid state (before being frozen later on). The ingredient mix can comprise sugars or sweetening agents, fats such as butter, cream or vegetable fat, milk, eggs, milk solids non fat, stabilizers, emulsifiers, fruit purees (for fruit based sorbets and ice creams), colours, flavours and water.

b) A pasteurizing unit able to process the prepared ingredient mix. Typical temperatures are between 80° C. and 90° C. during 20 to 40 seconds.

These conditions have to be seen in contrast with typical UHT conditions where the temperature is e.g. between 135° C. and 150° C. for 2-3 seconds.

Pasteurization, due to the limited heat treatment used to process ice-cream mixes compared to other known technologies (such as e.g. UHT), preserves the quality of raw materials in a better way, minimizes the occurrence of off-flavours, preserves the natural aspect of colours used in the preparation, overall reducing the risk of thermal degradation due to high temperatures. Pasteurization assures good microbiological mix conditions and preservation of the initial characteristics of the mix itself. The pasteurization process is done applying time/temperature parameters that are well known and well applied in every ice cream industry, in ice cream artisanal laboratories or at the point of sales.

Pasteurized mixes, due to the nature of the heat treatment used, have a limited shelf-life if maintained at ambient temperature or in chilled conditions and must be processed in few hours/days into their final ice cream, sherbet or other frozen dessert form.

c) An ageing tank able to maintain in controlled chilled condition the ice cream/sherbet/frozen dessert mix until the filling phase. Typical temperatures during the ageing are chilled temperatures of between 2° C. and 8° C. Typically the ageing time applied could vary from 2 to 24 hours.

d) A packaging able to contain the ingredient mix.

This packaging needs to have a specific composition able to protect the mix contained for a long time, preventing oxidation and microbiological re-contamination, a good mechanical resistance to frosting and defrosting conditions.

e) A filler or filling system able to directly fill the liquid or viscous ingredient mix in a selected packaging. Through a filling device the pasteurized mix, maintained in chilled condition devoted ageing tanks, could be packed in individual bags.

Preferably the viscosity of the non-frosted premix is between 50 and 5000 cP, preferably between 100-1000 cP.

f) The packs are, through a sealing system, closed. A thermo-sealed membrane creates a closed system on the packaging that avoids any further contact with the external environment. A closing system, e.g. a sealing membrane of a selected material thermo-sealed on the packaging fitment or sealed with other technologies can guarantee a tamper-proof closure, which seals the filled packaging in an air-tight fashion.

g) Once closed, the packs are immediately frozen or through a static process (cold warehouse) or through cold tunnels or other cooling systems to reach in the minimum time the temperature of conservation. A cooling system able to cool the liquid mix to frozen conditions. This is typically done at temperatures of between −15° C. and −40° C. Typically the time is between some hours and a few days depending on the size of the product and the freezing conditions. The cooling system can be e.g. a hardening tunnel, a cold plate exchanger, an in-line freezer, or a cold storage space.

The result of this step is a frozen ingredient mix batch in a sealed package. “Batch” is meant to be understood as containing an amount for several typical frozen dessert servings. Typically a batch contains between 1 liter and 10 liters, preferably between 3 and 7 liters.

The shelf life time in the frozen state is at least several months.

h) A cold warehouse able to maintain the product in cold conditions, i.e. in the frozen state.

i) A cold distribution and transport system at controlled temperature, keeping the ingredient mix frozen.

j) A point of sale equipped with cold cabinets to stock the product and defrost it when it is necessary to process it.

A typical defrosting time would be between 10 and 48 hours in a chilled environment namely in conditions typically comprised between +2° C. and +6° C. The shelf life in the defrosted state is some 5 to 15 days in chilled environment.

k) A freezer or soft ice machine able to convert the mix in its final semisolid or solid form (frozen dessert e.g. ice cream or sherbet) ready to be served in these conditions to the consumers. The deep freezing stage preserves the quality of the goods even over longer periods, allows the maintenance of required microbial conditions inhibiting the bacteria grow, inhibiting the degradation process that has effect on quality of the goods and maintaining the initial food characteristics.

Using this technology, the products can then be delivered or transported far from the production site and, depending on their expected shelf life, consumption or final transformation could take place later on.

Additionally the product can be aerated e.g. in order to achieve an overrun of between 10% and 150%, preferably 20% and 80%, more preferably 25% to 70%. Freezer machines have the scope, using a combination of a phase of whipping/aeration inside a cylinder and a subsequent phase, through a compressor generated cold, necessary to cool down the mix, to change its physical state from liquid to semisolid or solid depending on the final temperature reached at the machine. At the meantime these machines during the process, take air from the environment, air necessary to give to the frozen dessert the desired overrun.

Preferably, after being processed into the freezer or soft-ice machine, the frozen dessert obtained could be cooled down in a blast-freezer, or other equipments able to cool down quickly the freshly produced frozen dessert, preserving the small ice crystals structure that typically gives a high quality perceived texture to the product.

Preferably after the process, the frozen dessert is then exposed in a scooping cabinet, allowing the maintaining of a correct temperature for final serving, typically between −10° C. and −18° C.

Liquid and puree flavourings can be added to the defrosted ingredient mix before the final freezing.

Solid materials, fruits, nuts, candies, chocolate grains or other raw materials normally used as inclusions are usually added after the product exits the batch freezer but could be also added directly into the batch freezer machine. As well for other liquid or viscous or semi-solid ingredients like toppings, ripples, sauces.

Thus, according to the invention, the maintenance of deep freezing conditions to the level required by laws and regulation is advantageously assured from the factory until the final customer through a cold chain distribution channel. In this type of distribution from the warehouse of the factory until the point of sale, through eventual intermediate warehouses or cold stocking areas and controlled temperature transports, goods are maintained always in frozen conditions. The respect of cold temperature conditions in all cold chain distribution channel allows the maintenance of the initial conditions for a long time, reported in shelf life indications for the good in the packaging.

1. A premix package comprising a batch of premixed, pasteurized ingredients for the production of a frozen dessert in a sealed packaging, the premix is in a frozen block state and not aerated.

2. A premix package according to claim 1, wherein the ingredients are selected from the group consisting of sherbet and ice cream ingredients.

3. The premix according to claim 1, wherein the batch is between 1 and 10 liters.

4. A method for producing frozen desserts, comprising the steps of:
producing a sealed premix package comprising a batch of premixed, pasteurized ingredients for the production of a frozen dessert;
freezing the premix package in a frozen block state, at a first site;
transporting the frozen premix package in the frozen state to a different, second site; and
producing an aerated frozen dessert, using a batch freezer or a soft-ice machine, using the frozen premix package.

5. The method according to claim 4, wherein the frozen premix package is defrosted at the second site before it is supplied to the batch freezer or to the soft-ice machine.

6. The method according to claim 4, wherein the ingredient mix is frozen after being directly filled in the package and after the package has been sealed.

7. The method according to claim 4, wherein the premix of ingredients is not subjected to an Ultra High Temperature process at the first site.

8. The method according to claim 4, wherein the second site is or selected from the group consisting of an ice-cream shop, a place where frozen desserts are produced and sold, and a mobile unit that dispenses frozen desserts.
